(19) United States
(12) Patent Application Publication
(10) Pub. No.: US 2022/0374418 A1
(43) Pub. Date: Nov. 24, 2022

(54) BLOCKCHAIN STRUCTURE FOR EFFICIENT SEARCHING

(71) Applicant: MICRO FOCUS LLC, Santa Clara, CA (US)

(72) Inventors: DOUGLAS MAX GROVER, Rigby, ID (US); Michael F. ANGELO, Houston, TX (US)

(21) Appl. No.: 17/764,954

(22) PCT Filed: May 19, 2021
(86) PCT No.: PCT/US2021/033217

§ 371 Date: Mar. 29, 2022

(51) Int. Cl. G06F 16/23; H04L 9/00

(52) U.S. Cl. CPC G06F 16/2379; H04L 9/50

(57) ABSTRACT

A determination is made that an event associated with a composite blockchain is a primary event or a secondary event. The composite blockchain comprises a primary blockchain and a first level sub-blockchain. In response to determining that the event is the primary event, a new block is dynamically added to the end of the primary blockchain. In response to determining that the event is the secondary event, the first level sub-blockchain is dynamically created. Dynamically creating the first sub-level blockchain comprises dynamically creating a first block in the first sub-level blockchain. This creates a branched blockchain that can be used for efficient searching.

### FIELD

The disclosure relates generally to blockchain and particularly to blockchain structures.

### BACKGROUND

The structure of traditional blockchains lends itself to be highly immutable. To gain this immutability, the blockchain structure contains a forward hash over the entire blockchain. The blocks in the blockchain typically represent events as they occur in time. As blockchains become very large, the traditional blockchain structure makes searching a large blockchain very inefficient. For example, in order to identify events associated with an individual user in a blockchain that captures user events, the whole blockchain has to be searched to identify individual events associated with a particular user. This is because the structure of the blockchain was designed for protection of the data, not for efficient searching.

in addition, because of the current structure of blockchain, over time, blockchains can have millions or even billions of blocks stored on a number of nodes. Verification of long blockchains in a distributed ledger can be become very processor intensive and impractical. For example, the article “The Cost of Bitcoin Mining Has Never Really Increased,” by Y-Der Song and Tomase Aste, October 2020, states, when discussing Bitcoin transactions that “the miners in the Bitcoin network are presently (May 2020) computing nearly 10²⁵ hashes per day, up over 10 orders of magnitude from the 2010 levels. We estimate in this paper that this hashing activity currently corresponds to an energy cost of around 1 million USD per day and around a billion USD over the past year. In turn, this corresponds a per transaction costs as high as 13 USD in January 2020.” What is needed is a new blockchain structure that is both efficient for searching and also reduces the hashing required.

### SUMMARY

These and other needs are addressed by the various embodiments and configurations of the present disclosure. A determination is made that an event associated with a composite blockchain is a primary event or a secondary event. The composite blockchain comprises a primary blockchain and a first level sub-blockchain. In response to determining that the event is the primary event, a new block is dynamically added to the end of the primary blockchain. In response to determining that the event is the secondary event, the first level sub-blockchain is dynamically created. Dynamically creating the first sub-level blockchain comprises dynamically creating a first block in the first sub-level blockchain. This creates a branched blockchain that can be used for efficient searching.

The present disclosure can provide a number of advantages depending on the particular configuration. These and other advantages will be apparent from the disclosure contained herein.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone. C alone, A and B together, A and C together, B and C together, or A, B and C together.

The term “a” or “an” entity refers to one or more of that entity. As such, the terms “a” (or “an”, “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROW, an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable. RF, etc., or any suitable combination of the foregoing.

The terms “determine”. “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “blockchain” as described herein and in the claims refers to a growing list of records, called blocks, which are linked using cryptography. The blockchain is commonly a decentralized, distributed and public digital ledger that is used to record transactions across many computers so that the record cannot be altered retroactively without the alteration of all subsequent blocks and the consensus of the network. Each block contains a cryptographic hash of the previous block, a timestamp, and transaction data (generally represented as a merkle tree root hash). For use as a distributed ledger, a blockchain is typically managed by a peep-to-peer network collectively adhering to a protocol for inter-node communication and validating new blocks. Once recorded, the data in any given block cannot be altered retroactively without alteration of all subsequent blocks, which requires consensus of the network majority. In verifying or validating a block in the blockchain, a hashcash algorithm generally requires the following parameters: a service string, a nonce, and a counter. The service string can be encoded in the block header data structure, and include a version field, the hash of the previous block, the root hash of the merkle tree of all transactions (or information or data) in the block, the current time, and the difficult) level. The nonce can be stored in an extraNonce field, which is stored as the left most leaf node in the merkle tree. The counter parameter is often small at 32-bits so each time it wraps the extraNonce field must be incremented (or otherwise changed) to avoid repeating work. When validating or verifying a block, the hashcash algorithm repeatedly hashes the block header while incrementing the counter & extraNonce fields. Incrementing the extraNonce field entails recomputing the merkle tree, as the transaction or other information is the left most leaf node. The body of the block contains the transactions or other information. These are hashed only indirectly through the Merkle root.

As described herein, a “genesis block” is the first block that is created for a blockchain. For each blockchain (or a composite blockchain), there is only one genesis block.

The term “transaction,” refers the data stored in blocks of a blockchain based on an event associated with the blockchain. For example, a transaction may be purchasing an item, a login event, an administration event, a network event, an anomaly event, and/or the like. Transaction data is basically any information associated with an event that is captured in a blockchain.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system that shows a blockchain in a distributed ledger.

FIG. 2 is a diagram of a blockchain.

FIG. 3 is a diagram of a composite blockchain that comprises a primary blockchain and a first level sub-blockchain for efficient searching.

FIG. 4 is a diagram of a composite blockchain that comprises a primary blockchain and a plurality of sub-blockchains levels for efficient searching.

FIG. 5 is a diagram of multiple blockchains that are linked together for efficient searching.

FIG. 6 is a flow diagram for adding blocks to a composite blockchain for efficient searching.

### DETAILED DESCRIPTION

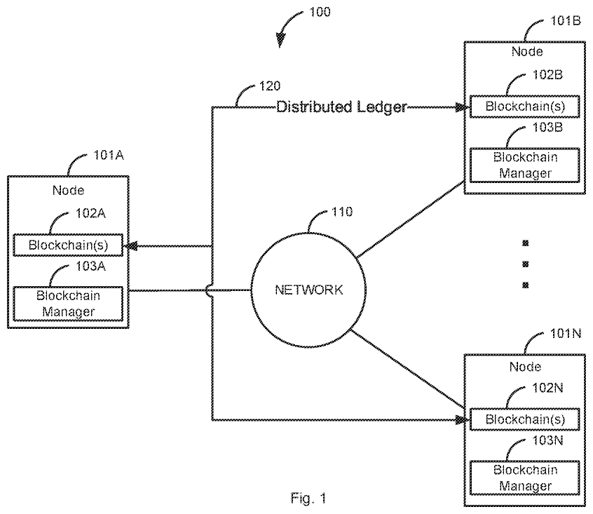

FIG. 1 is a block diagram of a first illustrative system 100 that shows a blockchain 102 in a distributed ledger 120. The first illustrative system 100 comprises nodes 101A-101N and a network 110.

The nodes 101A-101N can be or may include any hardware/software that can support the use of blockchains 102 in the distributed ledger 120, such as, a Personal Computer (PC), a server, a trust authority server, a gateway, a router, and/or the like. As shown in FIG. 1, any number of nodes 101A-101N may be connected to the network 110, The nodes 101A-101N further comprise blockchains 102A-102N and blockchain managers 103A-103N.

The blockchains 102A-102N are copies of the same blockchain 102 that comprise the distributed ledger 120, The size of the blockchains 102A-102N may vary based on implementation. The blockchains 102A-102N are a form of a replicated distributed database. As will be described later, the description of FIG. 1 will also work for a composite blockchain as described herein.

The blockchain managers 103A-103N can be or may include any hardware coupled with software that can manage the blockchains 102A-102N. The blockchain managers 103A-103N work together to determine how to manage the blockchains 102A-102N. For example, the blockchain managers 103A-103N may vote to validate a new block being added to the blockchains 102A-102N in the distributed ledger 120.

The network 110 can be or may include any collection of communication equipment that can send and receive electronic communications, such as the Internet. a Wide Area Network (WAN), a Local Area Network (LAN), a packet switched network, a circuit switched network, a cellular network, a combination of these, and the like. The network 110 can use a variety of electronic protocols, such as Ethernet. Internet Protocol (IP), Hyper Text Markup Language (HTML), Hyper Text Transfer Protocol (HTTP), Web Real-Time Protocol (Web RTC), and/or the like. Thus, the network 110 is an electronic communication network configured to carry messages via packets and/or circuit switched communications.

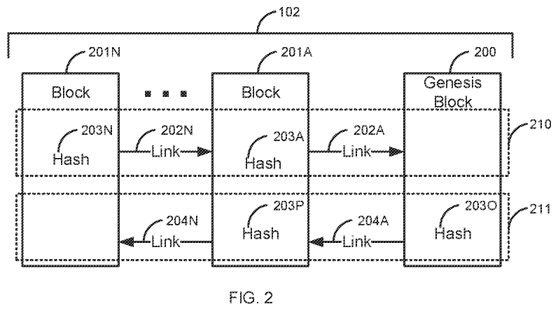

FIG. 2 is a diagram of a blockchain 102. Illustratively, the nodes 101A-101N, and the blockchain managers 103A-103N are stored-program-controlled entities, such as a computer or microprocessor, which performs the method of FIGS. 2-6 and the processes described herein by executing program instructions stored in a computer readable storage medium, such as a memory (i.e., a computer memory, a hard disk, and/or the like), Although the methods/structures described in FIGS. 2-6 are shown in a specific order or configuration, one of skill in the art would recognize that the steps/structures in FIGS. 2-6 may be implemented in different orders/structures and/or be implemented in a multi-threaded environment. Moreover, various steps ma be omitted or added based on implementation.

The blockchain 102 of FIG. 2 comprises a genesis block 200. block 201A, and block 201N. The designation “N” for block 201N (or any reference herein) indicates that there may be any number of blocks 201 in between blocks 201A and 201N, including zero blocks 201. The description generally assumes that there are not any blocks 201 between blocks 201A and 201N, in the blockchain 102 of FIG. 2, block 201N has a forward link 202N back to block 201A. Likewise, block 201A has a forward link 202A back to the genesis block 200. The hash 203N is a hash of the block 201A, Likewise, the hash 203A is a hash of the genesis block 200. The forward links 202A-202N and the hashes 203A-203N of the blockchain 102 comprise a complete forward hash 210 of the blockchain 102. Traditional blockchains 102 like Bitcoin™ use a complete forward hash 210 similar to what is described in FIG. 2 for verification of the blockchain 102.

The blockchain 102 may also comprise a complete reverse hash 211. The complete reverse hash 211 comprises reverse links 204A-204N and hashes 2030-203P. The hash 2030 is a hash of block 201A and the hash 203P is a hash of the block 201N. The reverse hash 211 is used to detect hash collisions that may occur in the forward hash 210. A hash collision is where two different sets of data produce the same hash. Thus, if a hacker has altered the data in the block 201A with new data that results in a hash collision of the hash 203N, the change can be detected by the complete reverse hash 211. The complete reverse hash 211 further ensures the integrity of the blockchain 102. However, the use of the complete reverse hash also has a cost of additional processing to ensure the integrity of the blockchain 102.

The hash 203 may be generated using known hashing algorithms, such Securing Hashing Algorithm (e.g. SHA 256), Message Digest Algorithm (e.g., MD 5), and/or the like. In one embodiment, instead of using a complete reverse hash 211, a second complete forward hash 210 may be used where two different hashing algorithms (e.g., SHA 256 and MD 5) may be used to detect hash collisions.

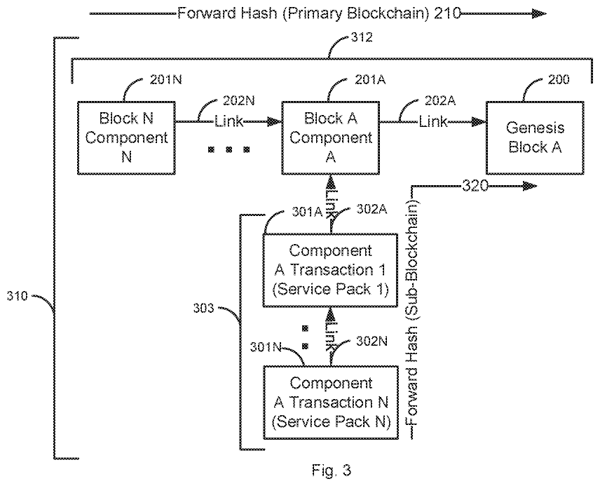

FIG. 3 is a diagram of a composite blockchain 310 that comprises a primary blockchain 312 and a first level sub-blockchain 303 for efficient searching. in FIG. 3, the primary blockchain 312 and first level sub-blockchain 303 are shown in regard to an exemplary embodiment for tracking software components installed on a system. As discussed in FIG. 3, a primary event is when a new component (e.g., a dynamic link library or class library of an application) is first installed on the system. Second level events for the composite blockchain 310 are where a component is upgraded. For example, when a service pack is installed on the system that upgrades the component.

The primary blockchain 312 comprises the blocks 201A-201N and the genesis block 200 (similar to the blockchain 102), in FIG. 3, the primary blockchain 312 contains blocks 201A-201N that are associated with primary events (new components) and a first level sub-blockchain 303 that links to the primary blockchain 312.

Like in FIG. 2, the primary blockchain 312 comprises the forward links 202A-202N. Although not shown for convenience, the blocks 201A-201N also comprises the hashes 203A-203N. In this example, the primary blockchain 312 has the complete forward hash 210.

The first level sub-blockchain 303 comprises blocks 301A-301N. The first level sub-blockchain 303 also comprises forward links 302A-302N. The forward links 302A-302N work similar to the forward links 202A-202N that points back to the block 201A. Like the blocks 201A-201N, the blocks 301A-301N, although not shown for convenience, also comprise hashes similar to the hashes 203A-203N.

When a new component is installed on the system (a primary event), a new block 201 is created at the end of the primary-blockchain 312 that has the Information associated with the component who/what installed, date, time, size, version, etc.). In FIG. 3 components A-N have been installed on the system. As a result, blocks 201A-201N were added to the primary blockchain 312.

In the future, as a new event (a secondary event) associated with the component occurs (e.g., a new service pack is installed to update component A), block 301A in the first level sub-blockchain 303 is created (a block for Component A Transaction 1 (Service Pack 1)) that has a forward link 302A to the component block 201A. In this example, the block 301A contains information about the updated component (e.g., who/what installed, date, time, size, version, service pack, etc.) similar to the block 201A. Likewise, when component A is upgraded a second time (e.g., service pack N), the block 301N is added in a similar manner to the first level sub-blockchain 303. The block 301N has a forward link 302N to the block 301A.

The block 301A is different in that it is not a genesis block 200 for a new blockchain 102; instead the block 301A is a regular transaction block (similar to block 201). In other words, there is only a single composite blockchain 310 with a single genesis block 200 that has different branches.

When the first level sub-blockchain 303 is initially created, verification of an encryption key/digital certificate can be used to verify the transaction is valid and a consensus vote of the nodes 101A-101N in the distributed ledger 102 can also be used to verify the transaction when adding a new block 301A in the level one sub-blockchain 303.

The integrity of the primary-blockchain 312 can be verified like traditional blockchains 102 by checking the forward hash 210 of the primary blockchain 312 back to the genesis block 200. The integrity of the first level sub-blockchain 303 can also be verified by verifying each block 301A-301N in the first level sub-blockchain 303 back to the component block 201A and then back to the genesis block 200 as shown by the forward hash sub-blockchain arrow 320. Thus, the immutability of traditional blockchains 102 remain while increasing the ability to search the composite blockchains 310 more efficiently. For example, instead of having to search all the blocks 201 in a traditional blockchain 102, if a user wanted information about a specific component (e.g., component A), the primary blockchain 312 would have to be searched to find component A (block 201A). Once found, all the information associated with component A can be found in block 201A and blocks 301A-301N of the level one sub-blockchain 303.

Another advantage to the composite blockchain 310 of FIG. 3 is that verification a new block 301 added to the first level sub-blockchain 303 only requires verification as shown by the forward hash sub-blockchain arrow 320. With traditional blockchains 102, since there would be a single blockchain (that would have blocks 201A-201N and 301A-301N), each block (201A-201N and 301A-301N) would have to be validated.

The process of FIG. 3 will also work where the primary blockchain 312 and the first level sub-blockchain 303 have a forward hash and/or a reverse hash.

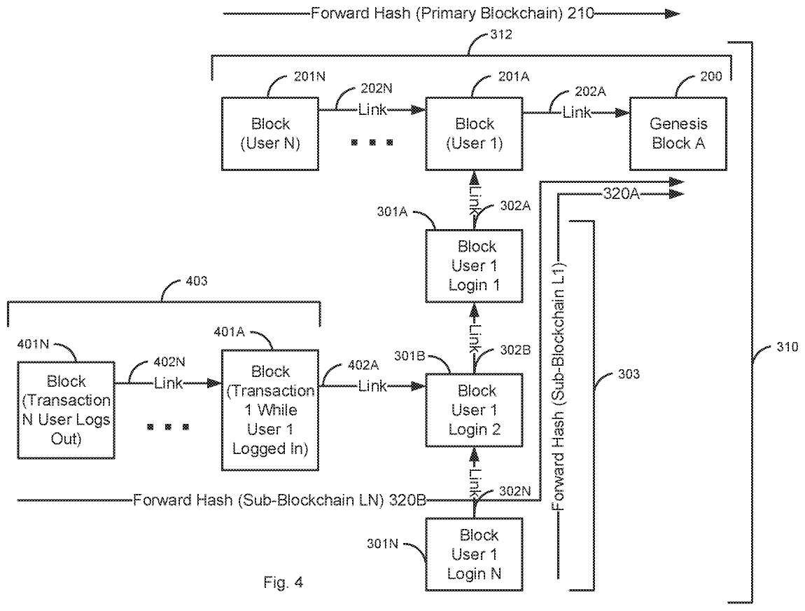

FIG. 4 is a diagram of a composite blockchain 310 that comprises a primary blockchain 312 and a plurality of sub-blockchains levels 303/403 (two levels) for efficient searching, FIG. 4, like FIG. 3 comprises the primary blockchain 312 and the level one sub-blockchain 303. In addition, FIG. 4 comprises a level two sub-blockchain 403, The level two sub-blockchain 403 comprises blocks 401A-401N. The blocks 401A-401N has forward links 402A-402N that work similar to the forward links 301A-301N. Although not shown for convenience, the blocks 401A-401N also comprises hashes (e.g., similar to the hashes 203A-203N).

The block 401A, like block 301A is different in that it is not a genesis block 200 for a new blockchain 102; instead the block 401A is a regular transaction block (similar to block 201).

In FIG. 4, the composite blockchain 310 is used to monitor users. When a new user gets added to the system (a primary event), a new block 201 is added to the primary blockchain 312 that has data associated with the new user, such as, user name, address, title, date added, etc. Each time the user logs in (secondary a level two event), a new block 301 is added to the end of the level one sub-blockchain 303. After the user logs in, events associated with the user being logged (secondary level three events) in are stored in the blocks 401 in the level two sub-blockchain 403. The last block 401 in the level two sub-blockchain 403N is created when the user logs out. The last block 403N can have a parameter that indicates that it is a final block of the level two sub-blockchain 403 to prevent new blocks being added to the end.

As can be seen, the integrity of the forward hash of each level (including the primary blockchain 312) is maintained by tracing each hash back to the genesis block 200 as shown by the forward hash sub-blockchain arrows 320A and 302B. Thus, if a new block 401 was added to the level two sub-blockchain 403, the hash can be verified as valid back to the genesis block 200 in the primary-blockchain 312.

Assuming that there are ten thousand users where each user has ten thousand events over time, this would result in a traditional blockchain 102 that has one hundred million blocks. With traditional blockchains 102, all one hundred million blocks 201 would have to be searched to identify the ten thousand events associated with an individual user. With the composite blockchain 310 structure, only the primary blockchain 312 would have to be searched to identify the individual user (block 201A) and the associated blocks (301A-301N, and 401A-401N). In this example, the primary blockchain 312 has ten thousand blocks 201. The average search would only be five thousand blocks 201 versus the full one hundred million blocks 201 with traditional blockchains 102. In this example, the search time is reduced on average by 20,000 times.

Another advantage is that the composite blockchain 310 structure is user defined and can be structured based an the specific data that is being placed into the composite blockchain 310. In this example, if someone what to identify user events that occurred by a given user at a specific point in time, the structure is designed using rules to easily identify individual events based on how the composite blockchain 310 has been structured.

In addition, the composite structure could be created dynamically. For example, the structure could change over time based on machine learning where new rules are automatically generated.

Moreover, with this process, the amount of hashing required is dramatically reduced compared with traditional blockchains 102. With traditional blockchain 102, the forward hash would be verified when a new block is added at the end of the blockchain 102 (one hundred million hashes). Instead in this example, the hash for adding a new block in the level two sub-blockchain 403 would be (assuming the primary block 201A is in the is five thousandth block 201A in the primary blockchain 312), the login is the one thousandth login in the level one sub-blockchain 303, and there were one hundred events during the login in the level two sub-blockchain) 403, the verification of the forward hash would be over six thousand one hundred blocks (blocks 201/301/401) versus one hundred million blocks 201. If the new block 201 is for a new, user being added, there would be ten thousand and one hashes performed versus one hundred m inion hashes performed. As you can see, the overall time required for searching and the processing resources required for hash verification are dramatically reduced as the size of the composite blockchain 310 increases.

This process can work with an existing blockchain 102 if the traditional blockchain 102 only has a single type of event that has related events that are not currently being tracked. In addition, it could also work to create new composite britches in an existing blockchain 102.

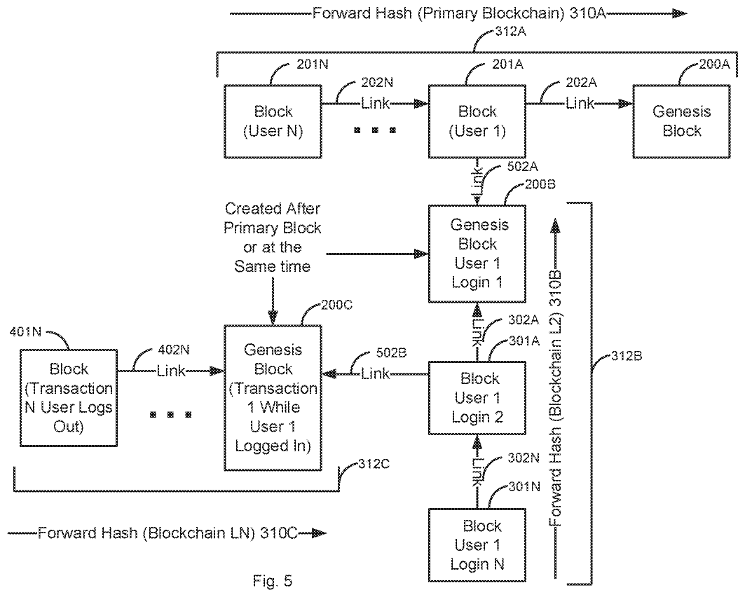

FIG. 5 is a diagram of multiple blockchains 312A-312C that are linked together for efficient searching. FIG. 5 comprises the blockchains 312A-312C. The blockchains 312A-312C are separate blockchains 102A-102N that each have a genesis block 200A-200C.

When a block (e.g., 201A) in the primary blockchain 312A gets created (assuming that the block 201A supports a second level blockchain 312B), the new block 201A comprises a reverse link 502A that points to the second level-blockchain 102B. The reverse link 502A is part of the new block 201A in the primary blockchain 312A. In this embodiment, the genesis block 200B is created at the same time as the new block 201A in the primary blockchain 312A. The block 201A in the primary blockchain 312A has a hash of the genesis block 200B (e.g., a forward and/or reverse hash (or two forward hashes using different algorithms)). The new genesis block 200B may also contain information about the primary block 312A, When a transaction (a second level event) occurs that is for the level two blockchain 312B (e.g., the user logging in), a block 301A for the transaction is then added to the level two-blockchain 312B after the genesis block 200B. In this case, the genesis block 200B is not a transaction block. This same process can then be used to create a level three blockchain 312C by creating the genesis block 200C and the reverse link 502B. This same process can be used to create additional lower level blockchains (e.g., based on a secondary level four blockchain event).

In a another embodiment (that is less secure), the link 502A is an empty link (but is part of the hash) that points to an uncreated blockchain 102. When the first transaction for the level one blockchain 102B occurs, a new genesis block 200B is created that has the transaction data. If a consensus is determined by the nodes 101A-101N, each node 101 in the distributed ledger 120 adds the new genesis block 200B for the level one blockchain 312B. Once in the distributed ledger 120, it is secure because of the redundancy of the distributed ledger 120, The same processes can be used to create second level blockchains 3120 and so on. Alternatively, there is a link 502A, but it is not part of the hash for the block 201A, This way the second level blockchain 312B can be added on the fly along with the link 502A being added to the block 201A.

In a another embodiment, the structure of the blockchains 312A-312C (e.g., the links 502) are maintained externally in a database. In this embodiment, there is no link 502A/502B in the blocks 201A/301A. When a new transaction occurs, the system determines if it is a primary event, a secondary event (e.g., a first level event, a second level event, and so on). The system then updates the appropriate blockchain 312A-312C.

These two processes also reduce the amount of hashing required versus traditional blockchains 102 because only the blockchain 102 where the new block is added is used for checking the forward hash of the blockchain 102.

The above processes described in FIGS. 2-5 may be used where only some blocks 201/301 in the primary blockchain 312 or sub-level blockchains 312B/312C have links 502A/502B. For example, the primary blockchain 312A may have some blocks 201 that don't have any related second level blockchains 312B (e.g., they are a different type of block that never has a second level blockchain 312B).

The above processes can also be used where the blockchains 312A-312C also contains a complete reverse hash 211. The complete reverse hashes 211 would work similar to traditional reverse hashes 211 where the process would do the reverse hash from the genesis block 200 back to the last block in the second level blockchain 312E or primary blockchain 312A. The advantage to doing a complete reverse hash 211 is that it protects against hash collisions. In addition, this process can also accommodate the use of a second forward hash that uses a different algorithm to identify hash collisions. Because of the reduction in processing resources needed, the ability to accommodate the use of a reverse hash 211/second forward hash becomes much more viable for long blockchains 102.

In addition, the above processes can be used where a consensus vote is need. Each node 101A-101N in the distributed ledger 120 can vote based on where the block 201/301/401 is to be added. The criteria may be based on determining the type of event versus where the block 201/301/401 is to be added, based on the type of event, the rules, and/or the like. If there is a consensus, the block 201/301/401 is added to all blockchains 312 in the distributed ledger 120 based on the vote of the majority.

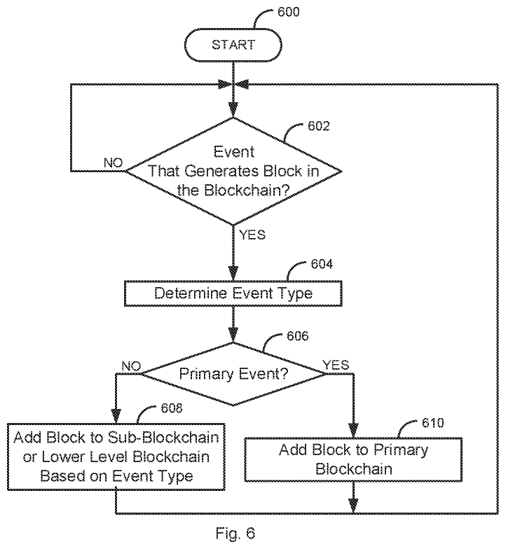

FIG. 6 is a flow diagram for adding blocks 201/301/401 to a composite blockchain 310/blockchain 312A-312C for efficient searching. The process starts in step 600. The process waits for an event that generates a block 201/301/401 in step 602. If there is an event that generates a block 201/301/401 in step 602, the process determines the event type in step 604. The process determines, in step 606, if the event is a primary event (e.g., adding a new user). If the event is a primary event, in step 606, the block 201 is added to the primary blockchain 312 (could also be primary blockchain 312A) in step 610. The process then goes back to step 602 to wait for another event.

Otherwise, if the event is not a primary event (e.g., a second level event), the process adds a block 301/401 to the appropriate level sub-blockchain 303/403 or level blockchains 312B/313C based on the rules in step 608. The process then goes back to step 602 to wait for another event.

As you look at the blockchain structures described in FIGS. 3-5, the primary blockchain 312A/312 and each level sub-blockchain 303/403 and blockchains 312B-312C are for a specific type of transaction. For example, the composite blockchain 310 in FIG. 4 is for creating a new user and then tracking the user. The first level sub-blockchain 303 is user login transactions, and the second level sub-blockchain 403 is for transactions while the user is logged on. To track the blocks 201/301/401; each block 201/301/401 may have a block type parameter. The system can keep track of the blocks 201/301/401 in the primary blockchain 312A/31.2/level sub-blockchains 303/403/level blockchains 312B-313C by tracking the block type or any other necessary data (e.g., the user name). This way, the system will know which level sub-blockchain 303/403/level blockchain 312B-312C to append the new block 201/301/401 to when the event type is determined in step 604.

Another key advantage of the processes described in FIGS. 3-6 is that blocks 301/401 can be added dynamically based on the rules. Thus, if the rules change, the structure of the composite blockchain 310 may dynamically change over time. For example, if a machine learning algorithm learns over time that a more efficient search is possible, the machine learning algorithm may dynamically add a new sub-level blockchain 303/403 or blockchain 312B/312C.

Examples of the microprocessors as described herein may include, but are not limited to, at least one of Qualcomm® Snapdragon® 800 and 801, QUalcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® JacintoC6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the System can be located remotely, at distant portions of a distributed network, such as a LAN and/or the Internet or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

in yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of One or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that when executed by the microprocessor, cause the microprocessor to:
determine that an event associated with a composite blockchain is a primary event or a secondary event;
in response to determining that the event is the primary event, dynamically add, a new block to the end of a primary blockchain; and
in response to determining that the event is the secondary event, dynamically create, a first level sub-blockchain, wherein dynamically creating the first sub-level blockchain comprises dynamically creating a first block in the first sub-level blockchain and wherein the composite blockchain comprises the primary blockchain and the first level sub-blockchain.

2. The system of claim 1, wherein the instructions further cause the microprocessor to: create a second block in the first sub-level blockchain based on a second secondary event, wherein the second block links back to the first block in the first sub-level blockchain.

3. The system of claim 1, wherein the event is the secondary event and
wherein the instructions cause the microprocessor to:
calculate a forward hash of the first level sub-blockchain back to a genesis block in the primary blockchain.

4. The system of claim 1, wherein the first sub-level blockchain further comprises a second level sub-blockchain and wherein the second level sub-blockchain links to a block in the first level sub-blockchain.

5. The system of claim 4, wherein the instructions further cause the microprocessor to: calculate a forward hash of the second level sub-blockchain back the first level sub-block chain and then back to a genesis block in the primary blockchain.

6. The system of claim 1, wherein determining that the event associated with the blockchain is the primary event or the secondary event is based on one or more rules and wherein the one or more rules are based on a more efficient search of the blockchain.

7. The system of claim 6, wherein the one or more rules are dynamically changed based on machine learning.

8. The system of claim 1, wherein the first block in the first sub-level blockchain is linked externally by a database.

9. The system of claim 1, wherein the first block in the first sub-level blockchain is not a genesis block of a separate blockchain.

10. A method comprising:
determining, by a microprocessor, that an event associated with a composite blockchain is a primary event or a secondary event;
in response to determining that the event is the primary event, dynamically adding, by the microprocessor, a new block to the end of a primary blockchain; and
in response to determining that the event is the secondary event, dynamically creating, by the microprocessor, a first level sub-blockchain, wherein dynamically creating the first sub-level blockchain comprises dynamically creating a first block in the first sub-level blockchain and wherein the composite blockchain comprises the primary blockchain and the first level sub-blockchain.

11. The method of claim 10, further comprising: creating a second block in the first sub-level blockchain based on a second secondary event, wherein the second block links back to the first block in the first sub-level blockchain.

12. The method of claim 10, wherein the event is the secondary event and further comprising:
calculating a forward hash of the first level sub-blockchain back to a genesis block in the primary blockchain.

13. The method of claim 10, wherein the first sub-level blockchain further comprises a second level sub-blockchain and wherein the second level sub-blockchain links to a block in the first level sub-blockchain.

14. The method of claim 13, wherein the instructions further cause the microprocessor to: calculate a forward hash of the second level sub-blockchain back the first level sub-block chain and then back to a genesis block in the primary blockchain.

15. The method of claim 10, wherein determining that the event associated with the blockchain is the primary event or the secondary event is based on one or more rules and wherein the one or more rules are based on a more efficient search of the blockchain.

16. The method of claim 15, wherein die one or more rules are dynamically changed based on machine learning.

17. The method of claim 10, wherein the first block in the first sub-level blockchain is linked externally by a database.

18. The method of claim 10, wherein the first block in the first sub-level blockchain is not a genesis block of a separate blockchain.

19. A system comprising:
a microprocessor; and
a computer readable medium, coupled with the microprocessor and comprising microprocessor readable and executable instructions that, when executed by the microprocessor, cause the microprocessor to:
determine that a first event is associated with a primary blockchain;
in response to determining that the first event is associated with the primary blockchain:
dynamically adding a new block to the end of the primary blockchain;
dynamically creating a second level blockchain, wherein the second level blockchain is created by creating a genesis block for the second level blockchain, wherein the new block comprises a hash of the genesis block; and
adding a reverse link that point from the new block to the genesis block.

20. The system of claim 19, wherein the second level blockchain only comprises the genesis block until a second event associated with the composite blockchain occurs at a later time.
